(19) United States
(12) Patent Application Publication
(10) Pub. No.: US 2019/0001231 A1
(43) Pub. Date: Jan. 3, 2019

(54) Portable Configurable Music Station

(71) Applicant: SCHMICK, LLC, Houston, TX (US)

(72) Inventors: Luke Schmick, Houston, TX (US); Alexandra Schmick, Houston, TX (US)

(21) Appl. No.: 15/640,527

(22) Filed: Jul. 1, 2017

(51) Int. Cl. A63H 5/00; G10D 13/08; G09B 15/00

(52) U.S. Cl. CPC A63H 5/00; G09B 15/00; G10D 13/08

(57) ABSTRACT

A musical learning apparatus comprising one or more frame members is disclosed. The apparatus also includes one or more connectors disposed on at least one of the frame members. The musical learning apparatus also includes music devices that are connected to the frame members using the connectors. The apparatus also includes one or more wires that connect the musical devices to frame members. The apparatus also includes frame inserts and insert sockets, wherein frame members are connected when a frame bolt is secured within the outer opening of a frame member and the frame insert of a separate frame member, and wherein when the frame members are connected they form a geometric shape.

### BACKGROUND OF THE DISCLOSURE

Musical instruments are very popular with young children. Particularly, toys which include musical devices are popular with young children because these kinds of toys stimulate the minds of children by allowing them to learn about both music and shapes. Toys such as these are more interesting to children than toys that do not have musical components or other sound producing elements, as the toys usually not as fun to play with. Also, because the children playing with toys where they do not learn about both shapes and music when interacting with the toy, the toys have limited educational benefit.

Moreover, some toys that include different shapes today are overly simplified, and as a result children are not even offered an opportunity to learn about the simplest of structural components, or the creativity involved in creating different shapes or designs of the toys. Learning about different configurations of devices such as toys, and learning how to configure them can assist children of all ages, because they will eventually grow and will want to play and explore using their full creativity. However, many toys today that can be reconfigured, cannot be reconfigured to form interactive, geometric shapes.

Further, many toys are not designed in a way that will reduce safety hazards for children. For example, some toys have buttons, knobs, switches and the like, which at times may break off or otherwise come apart. This can cause children playing with the toy to step on broken pieces, or swallow pieces, causing a choking hazards, or otherwise increasing the potential for injuring children that play with the toy. Also, for many toys, once a piece i.e., a button, knob, switch, or otherwise has been broken, or has otherwise come apart, the toy is typically incapable of functioning as intended without either, having the broken piece fixed using glue or some other method, or by replacing the entire toy itself.

It is therefore desirable to have an apparatus that may be used to learn about music and musical instruments. It is also desirable to have an apparatus that can be easily configured into different geometric shapes and designs. It is further desirable to have an apparatus that allows for teaching the basic structural components used to craft the geometric shapes and designs.

It is further desirable for the apparatus to have a size and material suitable for one or more children to be able to configure the apparatus into different shapes and designs. Moreover, it is also desirable to have an apparatus which includes a pin locking mechanism for positioning musical devices, so that the pins, buttons, etc., used for holding the musical instruments in place do not come apart, break, or otherwise create a safety hazard for children interacting with the apparatus. Furthermore, it is desirable for the apparatus to serve as a multi-purpose educational tool, while also remaining safe and aesthetically pleasing.

The subject matter of the present disclosure is directed to overcoming, or at least reducing the deficiencies of, one or more of the problems set forth above.

### SUMMARY OF THE DISCLOSURE

A musical learning apparatus comprising one or more frame members is provided. In one example, the apparatus includes one or more connectors disposed on at least one of the frame members. In another example, the musical learning apparatus also includes music devices that are connected to the frame members using the connectors. In yet another example, the musical learning apparatus also includes one or more wires that connect the musical devices to frame members.

The musical learning apparatus in another example includes frame inserts and insert sockets. In one example, the frame members of the musical learning apparatus are connected when a frame bolt is secured within the outer opening of a frame member and the frame insert of a separate frame member. In another example, when the frame members are connected they form a geometric shape.

The foregoing summary is not intended to summarize each potential embodiment or every aspect of the present disclosure.

### BRIEF DESCRIPTION OF THE DRAWINGS

FIG. 1 illustrates an example of a portable configurable music station configured in the form of a cube, according to the present disclosure.

FIGS. 2A-2B illustrate example views of a cube upper connect frame member according to the present disclosure.

FIG. 3 illustrates example views of a cube stabilizer frame member according to the present disclosure.

FIG. 4 illustrates another example view of the cube stabilizer of FIG. 3, according to the present disclosure.

FIGS. 5A-5B illustrate examples of a cube panel with interactive frame members, according to the present disclosure.

FIG. 6 illustrates an example internal view of the top of the cube panel, according to the present disclosure.

FIG. 7 illustrates another example internal view of the top of the cube panel, according to the present disclosure.

FIGS. 8A-8B illustrate example connections of the cube configuration of the portable configurable music station, according to the present disclosure.

FIG. 9 illustrates an example of a partial cube configuration having music device connectors and example music devices disposed, according to the present disclosure.

FIG. 10 illustrates another example view of a cube panel having a music device disposed on interactive frame members, according to the present disclosure.

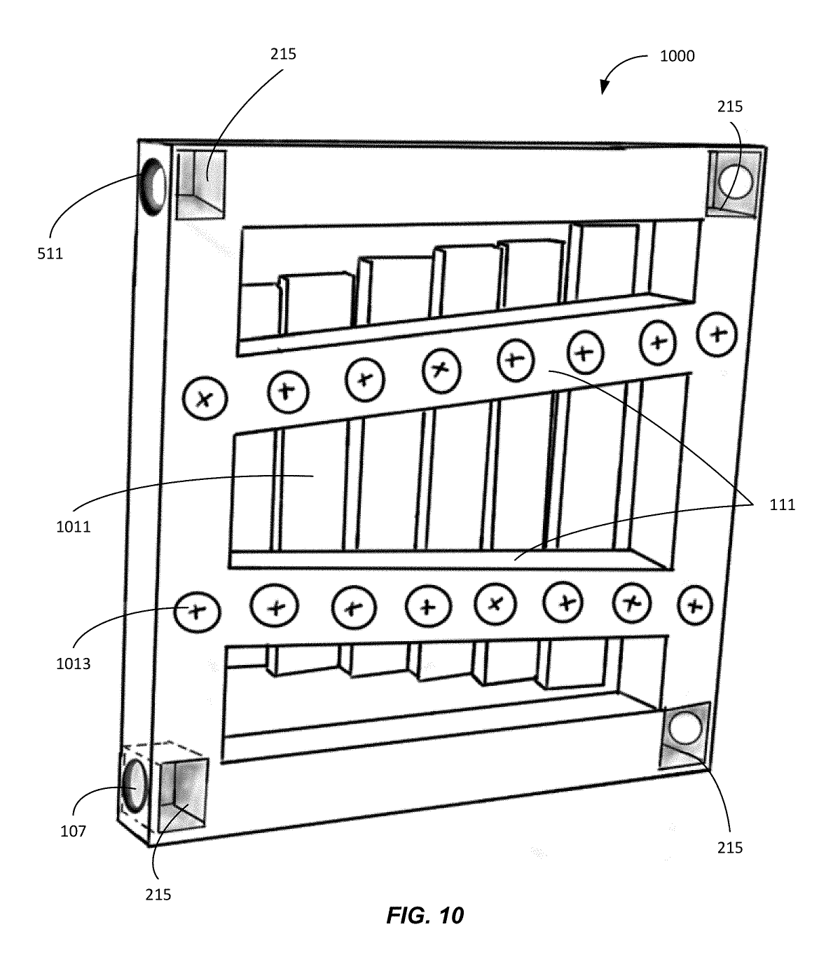

FIGS. 11A-11B illustrate an example views of portable configurable music station connections, according to the present disclosure.

FIGS. 12A-12B illustrate examples of different configurations of the cube configuration, according to the present disclosure.

FIG. 13 illustrates another example of the cube configuration having connectors and music devices disposed, according to the present disclosure.

FIG. 14 illustrates example frame members of a rectangle configuration of the portable configurable music station, according to the present disclosure.

FIG. 15 illustrates an example rectangle connect frame member of the rectangle configuration of the portable configurable music station, according to the present disclosure.

FIG. 16 illustrates an example rectangle panel frame member of the rectangle configuration of the portable configurable music station, according to the present disclosure.

FIG. 17 illustrates another example rectangle connect frame member of a rectangle configuration of the portable configurable music station, according to the present disclosure.

FIGS. 18A-18B illustrate an example of a mounting screw assembly being used to connect a music key to an interactive frame member, according to the present disclosure.

FIG. 19 illustrates an example of a locking pin assembly being used to connect a musical key to an interactive frame member, according to the present disclosure.

FIGS. 20A-20B illustrate different examples of the locking pin assembly, according to the present disclosure.

FIG. 21 illustrates another example of the locking pin assembly being used to connect a music key to an interactive frame member, according to the present disclosure.

FIG. 22 illustrates an example rectangle configuration of the portable configurable music station having connectors and music devices disposed, according to the present disclosure.

FIGS. 23A-23B illustrate example partial cube configurations having a modified cube stabilizer, according to the present disclosure.

FIG. 24 illustrates example frame members of a pyramid configuration of the portable configurable music station, according to the present disclosure.

FIGS. 25A-25B illustrate a top down cross-sectional view of the pyramid configuration showing example connections according to the present disclosure.

FIGS. 26A-26B illustrate example pyramid configurations of the portable configurable music station, according to the present disclosure.

### DETAILED DESCRIPTION OF THE DISCLOSURE

Overview of the System

In the following description, numerous specific details are set forth in order to provide a thorough understanding of the inventive concept. Furthermore, as part of this description, some of the drawings may represent structures and devices in block diagram form in order to avoid obscuring the invention. Accordingly, in the interest of clarity, all features of an actual implementation of the invention may not be described in the following description. Moreover, the language used in this disclosure has been specifically selected for readability and purposes of understanding, and may not have been selected to delineate or circumscribe the inventive subject matter. Thus, it may be necessary to further resort to the drawings and or claims for determining the inventive subject matter.

Furthermore, any reference in this disclosure to “one embodiment” or to “an embodiment” indicates that a particular feature, structure, or characteristic of the invention described in connection with the embodiment is included in at least one implementation of the invention. Multiple references to “one embodiment” or “an embodiment” should not be understood as necessarily referring to the same embodiment.

It will be appreciated that such invention development efforts may be complex and time consuming, but would nevertheless be a routine undertaking for those having ordinary skill in the design and implementation of a portable configurable music apparatus having the benefit of this disclosure.

The portable configurable music station i.e., the “music station” disclosed herein allows for the ultimate flexibility when adding or removing musical instruments, and or when configuring the music station into different geometric shapes. Further, because of its smaller design, the music station is ideal for use as an educational tool for teaching users, such as children, colors, sounds, geometric shapes, and how to configure the music station in an interactive way. The music station also uses a pin lock assembly to eliminate choking hazards from broken or removed parts, and which also allows the music station to be easily repairable.

The pin lock system as disclosed herein removes the need for bolts and or screws that may be sheared, broken, or removed while interacting with the musical devices. The music station includes two-dimensional shapes that may have different colors, thus teaching colors and shapes at the same time. The different frame members of the music station can be connected to form two-dimensional or three-dimensional geometric shapes. As a result, the music station has the additional advantage of teaching geometric shapes as well as configurability and design.

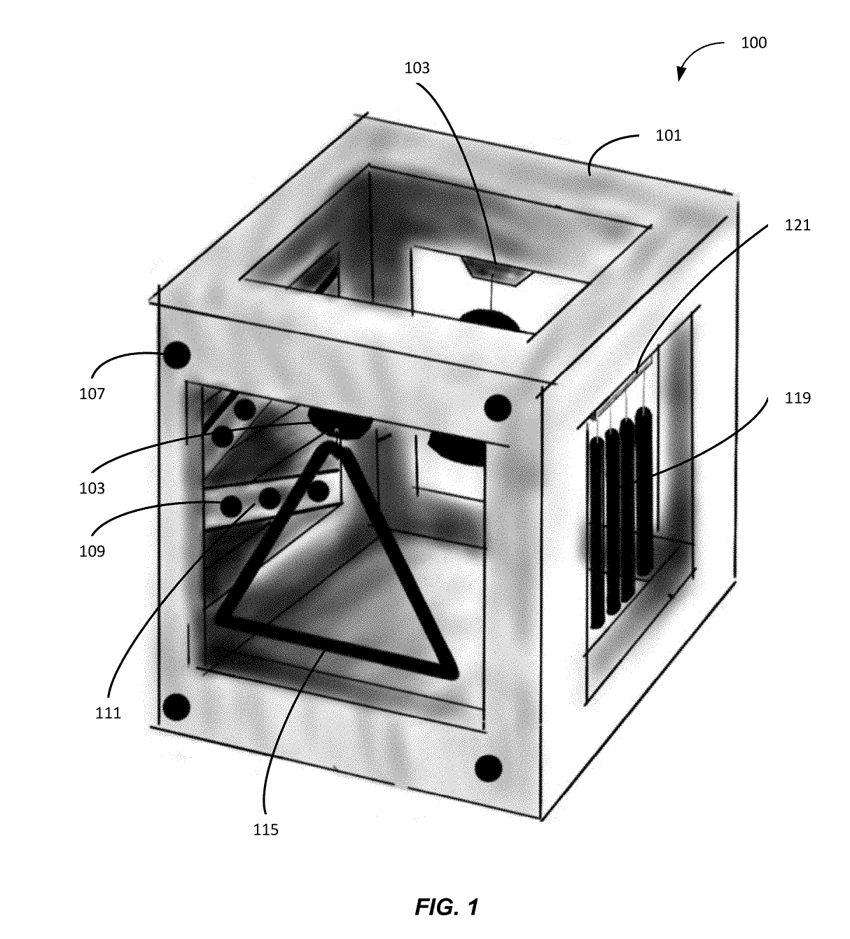

Referring now to FIG. 1, an example illustration of a music station configured in the form of a cube (i.e., cube configuration 100) is shown, according to the present disclosure. In a preferred embodiment, the cube configuration 100 is in the shape of a cube, having a cube frame which includes three cube frame members, discussed below. Although, the cube configuration is not limited to having three cube frame members, in a preferred embodiment of the invention the cube frame members include a cube upper connect 200, a cube stabilizer 300, and a cube panel 500, as discussed below.

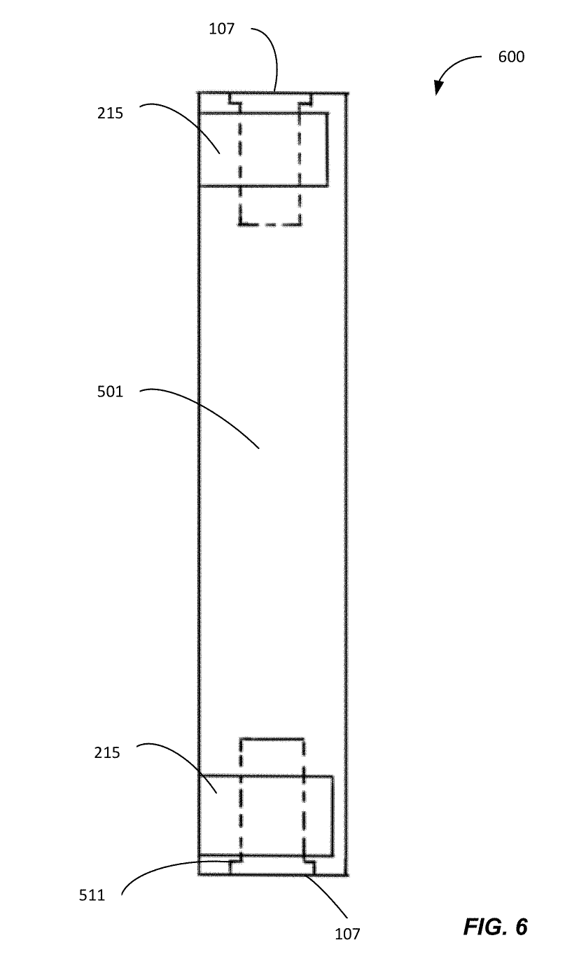

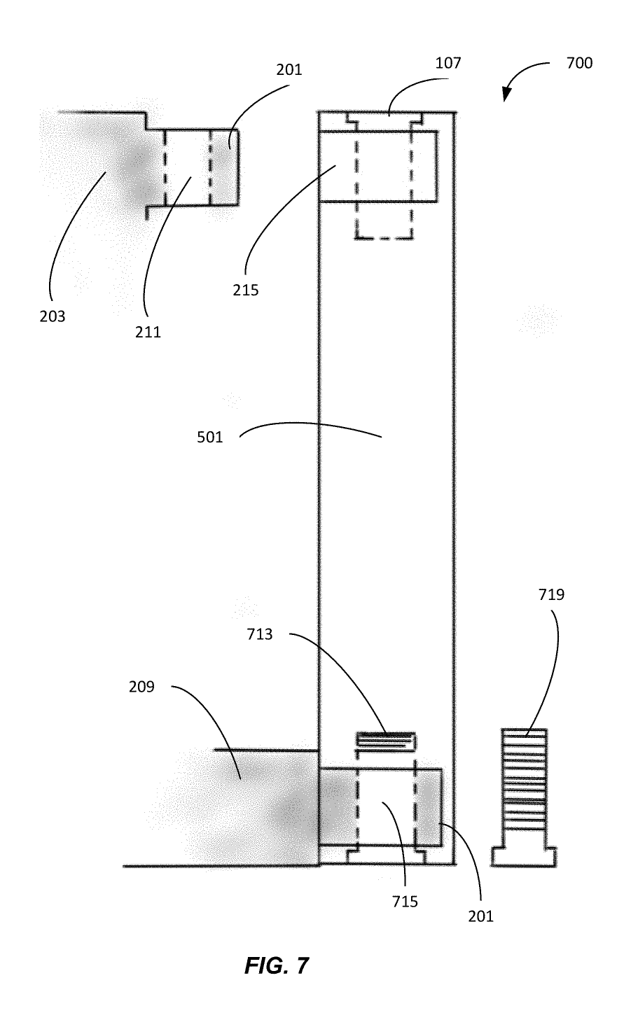

The cube frame members are connected to each other using frame bolts 719 as discussed with reference to FIG. 7. In an embodiment, the frame bolts 719 are inserted into the frame openings 107 of the cube configuration 100, which are indicated by the black dots on the exterior of the cube configuration 100. Although not limited to a particular diameter, in a preferred embodiment, each of the outer openings 107 shown on the cube frame 101 of the cube configuration 100 has a diameter of 0.75 inches. Furthermore, as shown in reference to FIG. 6 and FIG. 7, the outer openings 107 extend into the cube frame 101. Depending upon the configuration, the cube frame members discussed below may be connected in different ways, wherein the frame openings and associated frame bolts 719 that connect the frame members may differ in location.

Referring to FIG. 1, in an embodiment of the invention, the cube configuration 100 may include one or more interactive frame members 111 the cube frame members. The interactive frame members 111 may be used for connecting certain types of music devices on a music station frame member, such instruments may be xylophones, cymbals, or other like music devices. The interactive frame members 111 may be part of the cube frame 101, and may also include one or more locking pin openings 109. In other embodiments however, interactive frame members 111 may be attached to the frame members of the music station using screws, bolt, nails, adhesive, or the like.

As discussed below, the locking pin openings 109 are used to connect music devices to the different configurations of the music station. It is important to note that the music station can be configured in the form of more than just the cube configuration 100, and that the music station can be configured in other geometric shapes, using different frame members as discussed below.

Further illustrated in FIG. 1, the cube configuration 100 may have connectors 103, multi-connectors 121, as well as other connectors such as parallel connectors 919 in order to connect music devices to the music station. In one embodiment, connectors are not specific to the cube configuration 100, and may be used in other configurations of the music station. The connectors discussed above, and discussed in detail below, may be used to connect music devices such one or more of a triangle 115, chimes 119, a bell 918, music device keys 1011, and the like; however other music devices used and or connected to the configurable music station, may be cymbals, musical wheels or devices that spin and or light up, or other like devices as known in the art.

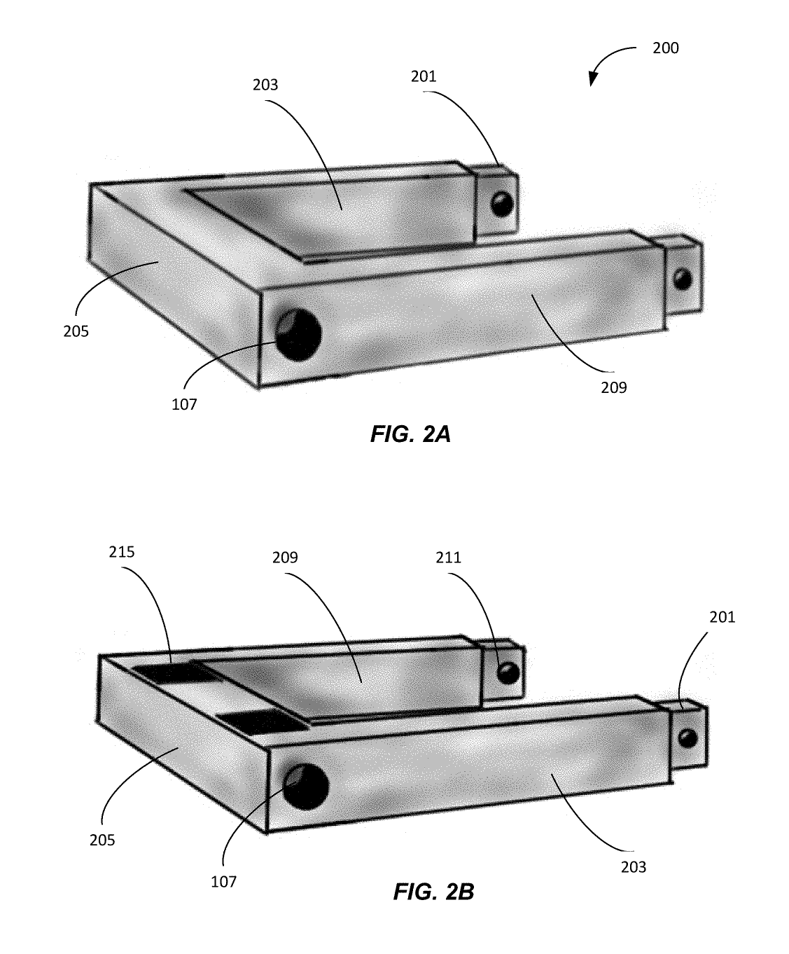

Referring now to one of the cube configuration's 100 cube frame members, FIGS. 2A-2B illustrate example views of the cube upper connect 200 according to the present disclosure. As shown, in a preferred embodiment of the invention the cube upper connect 200 has the shape of a horseshoe. Preferably, the cube upper connect 200 is a single frame member which includes an upper connect top 205 and a first and a second upper connect arm 203 and 209, respectively; however, in other implementations these attributes can differ. In a preferred embodiment, the cube upper connect 200 first connect arm 203 and second arm 209 are separated by the inner width of the upper connect top 205. Further, in one embodiment, the upper connect top 205 has the same as the length as each external side of the cube configuration 100, preferably 6.5 inches, but in other embodiments, other dimensions may be used.

In another embodiment however, the length of each upper connect arm (203, 209) is the same as the length of the upper connect top 205. Also, as shown in FIG. 2A and FIG. 2B, in a preferred embodiment, the cube upper connect 200 has frame inserts 201 extending from each upper connect arm (203, 209). In one implementation of the invention, each frame insert 201 is cube shaped and preferably has a length of an inch, however in other embodiments the dimensions may be greater or less.

Further, in one embodiment each frame insert 201 has an insert opening 211 that extends through both sides of the frame insert 201. As discussed below, a frame bolt 719 may be used to connect frame members of the different configurations of the music station. In a preferred embodiment, the frame members of the music station e.g., the cube upper connect 200, and or other frame members of the music station, comprise of a hard-plastic material, and has one or more colors. However, in other embodiments the frame members may comprise wood, metal, or other material.

Referring again to FIG. 2A and FIG. 2B, the cube upper connect 200 preferably has two outer openings 107, one on each side; although in FIG. 2A only one outer opening 107 is shown, the other outer opening 107 is on the opposite side of the cube upper connect 200, as illustrated in FIG. 2B. Also, as shown in the illustration of FIG. 2B, the cube upper connect 200 has two insert sockets 215 disposed within the upper connect top 205. In a preferred embodiment, the insert sockets 215 are used to connect the cube upper connect 200 to other frame members such as the cube stabilizer 300, to form cube configuration 100.

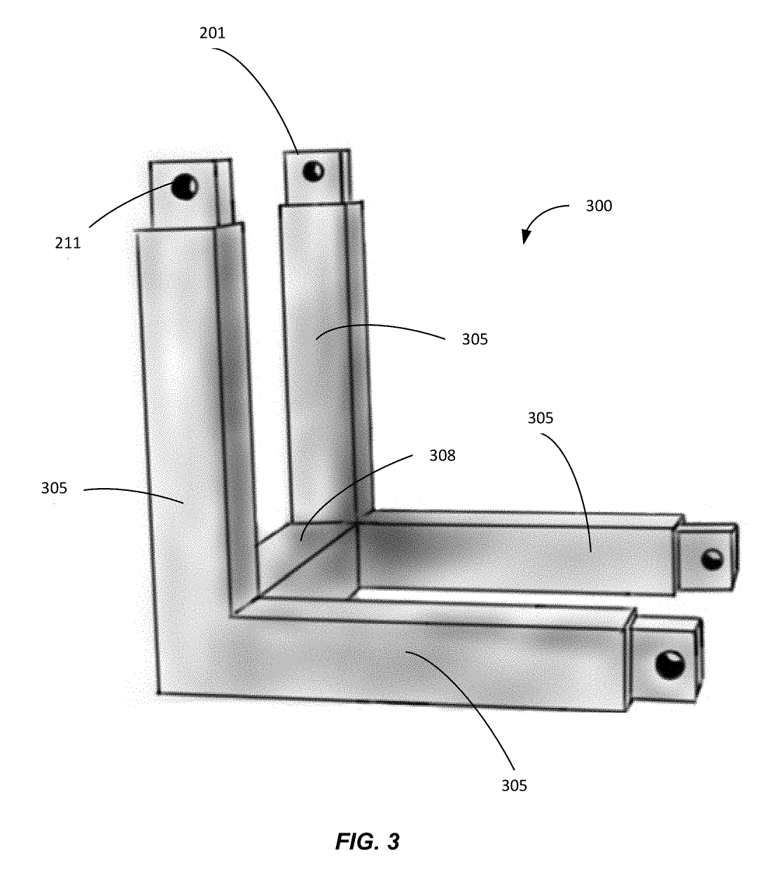

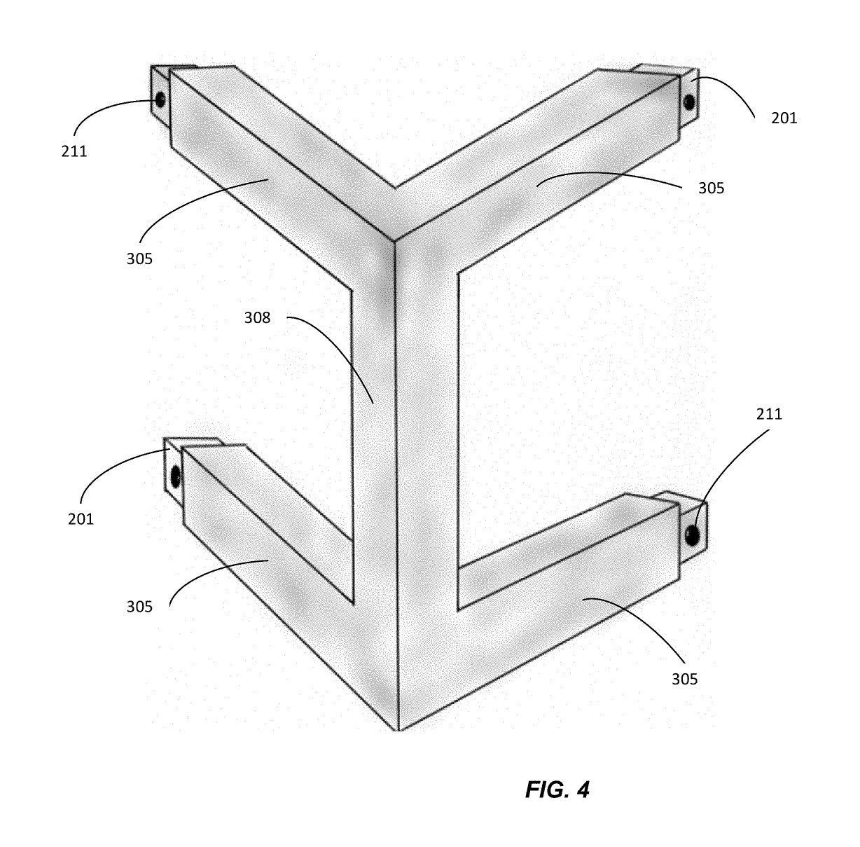

FIG. 3 illustrates example views of a cube stabilizer 300 according to the present disclosure. As shown in FIG. 3 and FIG. 4, in an embodiment the cube stabilizer 300 has four stabilizer arms 305, wherein each of the stabilizer arms 305 has a frame insert 201 extending from the end of each arm 305. As illustrated, each frame insert 201 has a frame insert opening 211 which extends through each frame insert 201. In a preferred embodiment, the length of each cube stabilizer arm is the same length of the stabilizer bridge 308 and each side of the cube configuration 100 shown in FIG. 1. However, in other embodiments the dimensions of the frame members may differ, as long as when the frame members of the cube configuration 100 are connected, they form a cube shape.

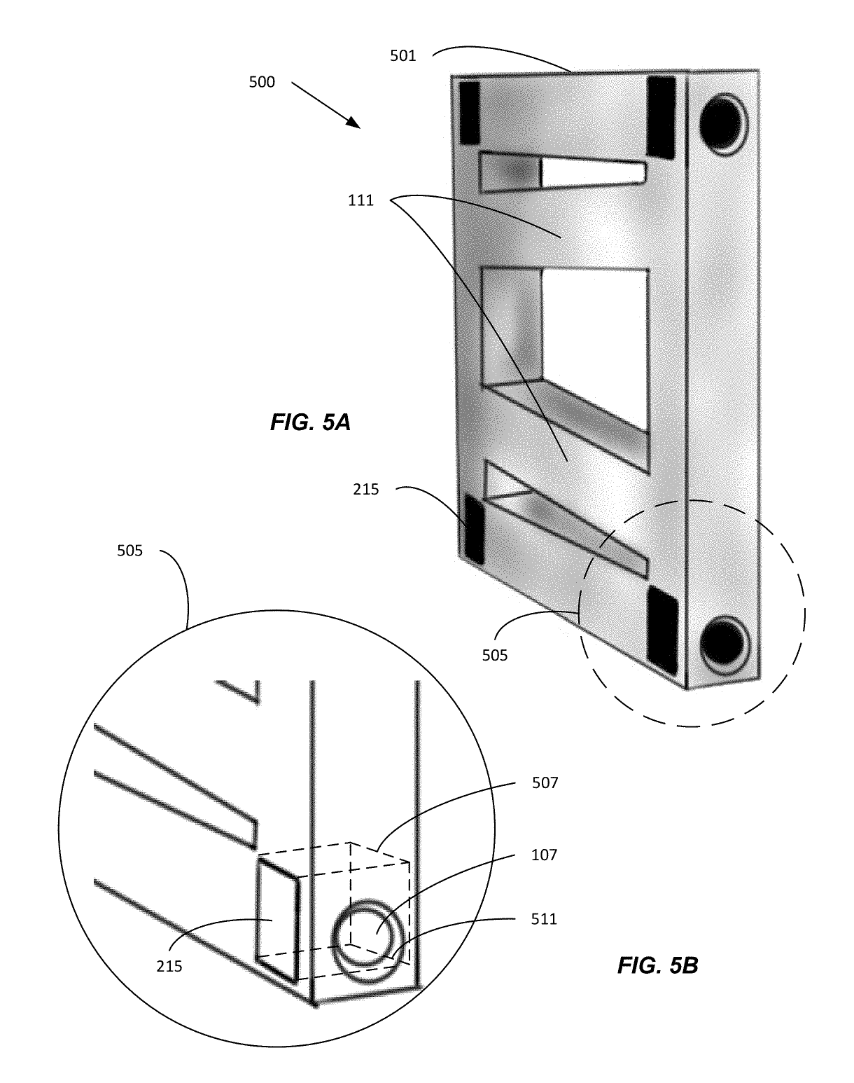

Referring now to the discussion of another frame member of the cube configuration 100, FIGS. 5A-5B illustrate examples of a cube panel 500 having interactive frame members 111, according to the present disclosure. As shown, in a preferred embodiment, the cube panel 500 has four frame insert sockets 215, one in each of the outermost corners of the cube panel 500. In one embodiment of the invention, the frame insert sockets 215 may have a square shape on the face of a frame members such as the cube panel 500, and preferably each insert socket 215 is suited to allow the frame inserts 201 to be inserted within. Moreover, as shown in FIG. 5B at 505, the insert sockets 215 also extend within the frame members (e.g., the cube panel 500), and in one implementation they extend the length of the frame inserts 201 discussed above.

FIG. 5B shows an internal view of a frame insert socket 215 and outer opening 107 combination of the cube panel. As shown, in one example the insert socket 215 and the outer opening 107 extend perpendicularly to one another within the cube panel 500. As described above, the outer openings 107 are openings at the exterior of each frame member configuration of the music station, and as shown in FIG. 5A, are at all four corners of the cube panel 500. In one implementation, the outer openings 107 have an outer opening offset 511, so that when frame members of the music station are connected and the frame bolts 719 are in place as described below, the frame bolt 719 will be disposed completely within each frame member so that no part of the frame bolt 719 protrudes.

The description will now turn to the connection of the frame insert 201, the insert socket 215, the outer opening 107, using a frame bolt 719. Both FIG. 6 and FIG. 7 illustrate example internal views of the cube panel top 501 according to the present disclosure. As shown in FIG. 6, in one embodiment the outer openings 107 are at the exterior of the cube panel 500 and extend through the insert sockets 215. Further, although only the cube panel top 501 is shown, all four corners of the cube panel 500 have outer openings 107 which extend perpendicularly through insert socket 215 of the cube panel 500.

As shown in FIG. 7 however, in a preferred embodiment of the invention, the frame inserts 201 discussed above are inserted into insert sockets 215 of the music station frame members. As discussed above, the insert sockets 215 extend within the cube panel 500 to allow the frame inserts 215 to be disposed within. In the example illustration of FIG. 7, it is illustrated how the cube upper connect 200 is connected to the cube panel 500 using the first and second arms (203, 209) of the cube upper connect 200.

In a preferred embodiment, when each of the frame inserts 201 has been inserted into the insert sockets 215 of the cube panel top 501, frame bolts 719 are inserted into the outer openings 107 as shown, and extend through each frame insert opening 211 to connect the cube upper connect 200 to the cube panel 500. In an example, frame bolts 719 may be inserted into the outer openings 107, and extend through the outer insert openings 211 through the outer opening chambers 715.

In another embodiment, as shown, toward the back of each of the outer openings 107 may be locking thread 713. Once the frame bolts 719 are completely inserted within the outer opening chambers 715, the frame bolts may be secured in place by connecting the thread of the frame bolts 719 to the locking threads 713. In another embodiment, the locking thread 713 is not limited to the location the back of the outer opening chamber 715, but all or part of the outer opening chamber may be threaded and used to secure the frame bolt 719 as discussed above.

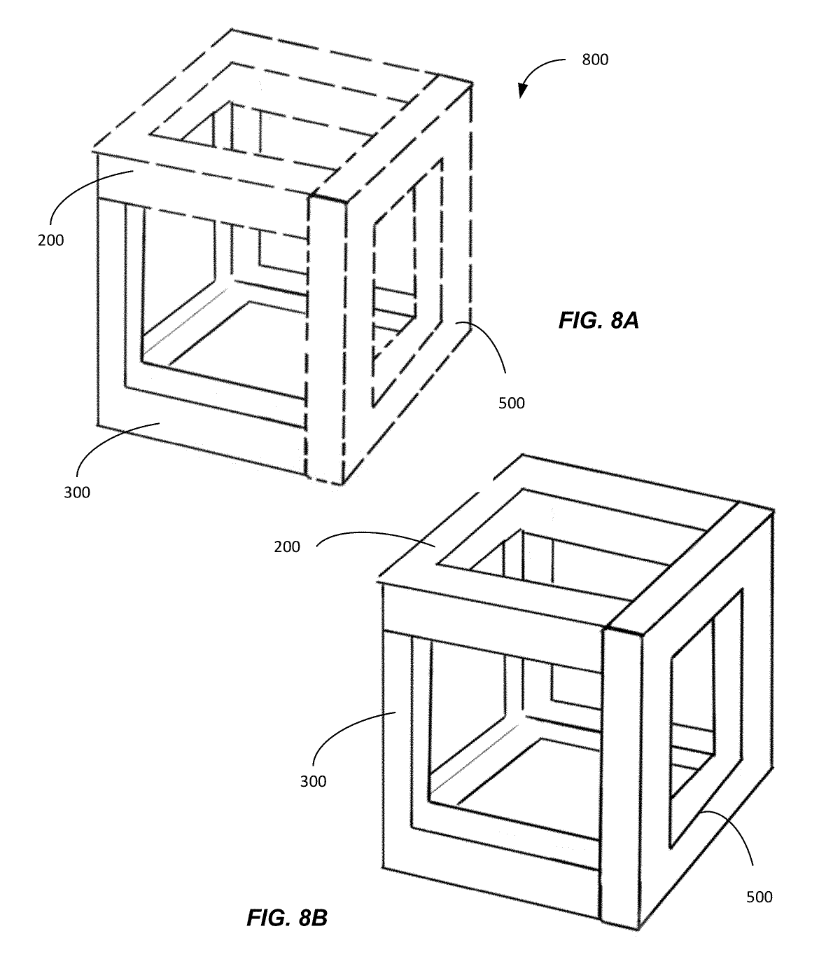

Referring now to the illustrations of FIGS. 8A-8B. As illustrated, example connections of the cube configuration 100 is shown, according to the present disclosure. In FIG. 8A, in a preferred embodiment, the cube configuration 100 comprises three frame members, the cube upper connect 200, the cube stabilizer 300, and the cube panel 500. As shown, the cube stabilizer 300 is connected to the upper connect 200 and the cube panel 500. In a preferred embodiment, the two frame inserts 201 towards the top of the cube stabilizer 300 as shown in FIG. 3, are inserted in the insert sockets 215 of the cube upper connect 200. As discussed above, the two frame members i.e., the cube stabilizer 300 and the cube upper connect 200, are connected when frame bolts 719 are inserted into the outer openings 107, through each of the insert openings 211 within the cube stabilizer 300 frame inserts 201, and secured using the locking thread 715.

Referring again to FIG. 8A, in a preferred embodiment the cube stabilizer 300 is connected to the cube panel 500 by securing the frame inserts 201 at the bottom of the cube stabilizer 300, as shown in FIG. 3, within the insert sockets 215 at the bottom of the cube panel 500, using frame bolts 719 as discussed above. FIG. 8B illustrates an example implementation of the music station cube configuration 100 according to the preferred embodiment of the invention.

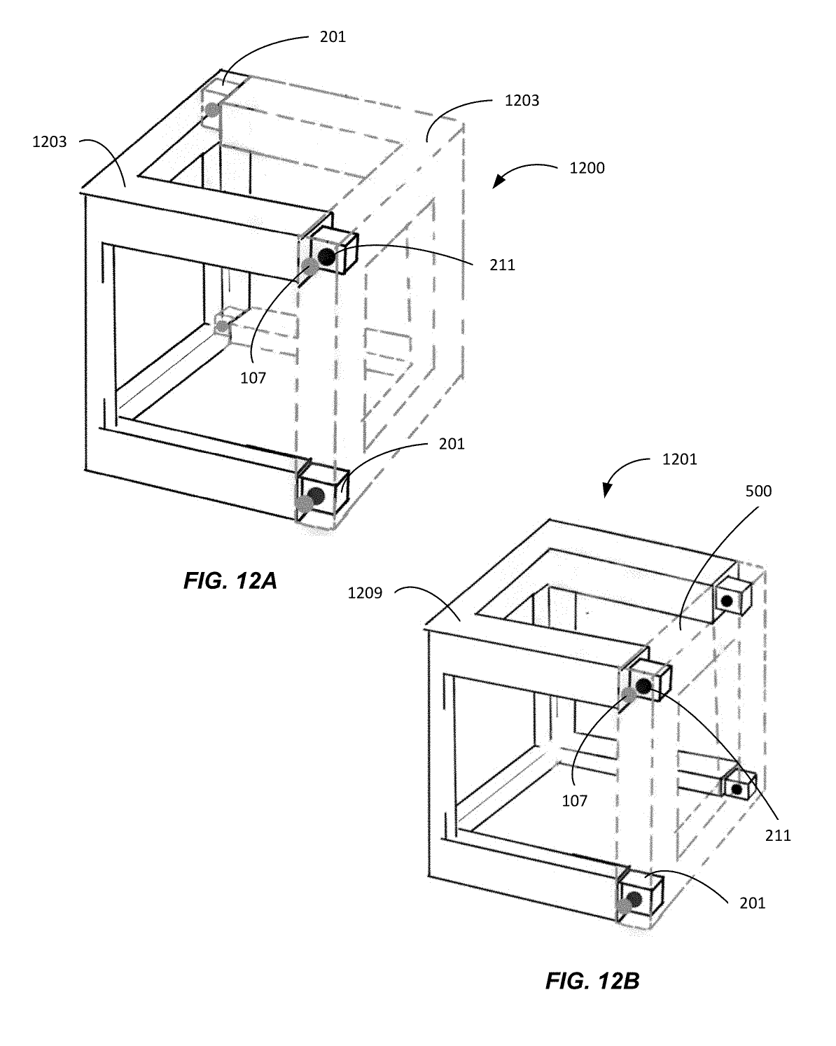

As shown in FIG. 8B, when the frame bolts are secured, the top of the cube panel 500 is connected to the cube upper connect 200, the cube upper connect 200 is connected to the top of the cube stabilizer 300, and the bottom of the cube panel 500 is connected to the bottom of the cube stabilizer 300. In this embodiment, once all three frame members of the cube configuration 100 have been connected, the cube configuration 100 of the music station is formed. It will be appreciated however, that the cube configuration 100 is not limited to being formed using the three frame members discussed above, and may be formed using other frame member designs, as discussed further referring to FIG. 12A and FIG. 12B.

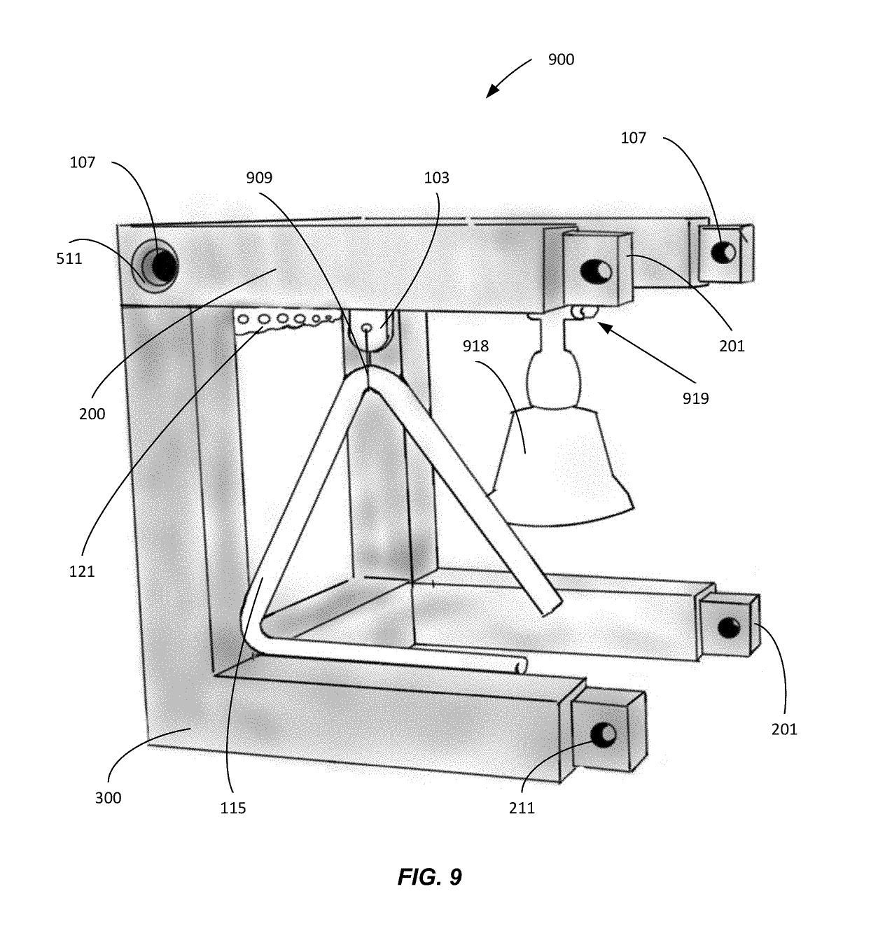

FIG. 9 illustrates an example partial cube configuration 100 of the music station having connectors and example music devices disposed. In one embodiment, and as shown extending from the cube upper connect 200 is a connector 103, a multi-connector 121, and a parallel connector 919. In one embodiment, each of the connectors above are used to connect music devices to the music station. Further, in a preferred embodiment, each of the connectors (103, 121, and 919) are comprised of the same material as the frame members themselves. However, a plastic material, wood, and or metal may be used; or other materials suitable for providing a stable connection for connecting music devices to the music station. In one embodiment, one or more of the connectors (103, 121, and 919) may be an extension or a part of the frame members of the music station. However, the invention is not limited in this aspect, and in another embodiment, the connectors (103, 121, and 919) may be fastened to the music station using nails, screws, bolts, or the like.

Referring to the connector 103 of FIG. 9, in an embodiment of the invention connector 103 may have a tab like form and extend e.g., away from the cube upper connect 200 as shown. In a preferred embodiment, the connector 103 includes an opening throughout its center, and may be used to allow wires 909 to be threaded through, to connect a music device such as a Triangle 115 as shown. It will be appreciated that the invention is not limited to using a wire, but that wire 909 may comprise a string, a chord, flexible bandlike material, or the like. Also, as shown in FIG. 9, though the connector 103 is centered along the bottom of the cube upper connect 200, the connectors (103, 121, and 919) are not limited to being centered along frame members, and may be otherwise positioned along the frame members.

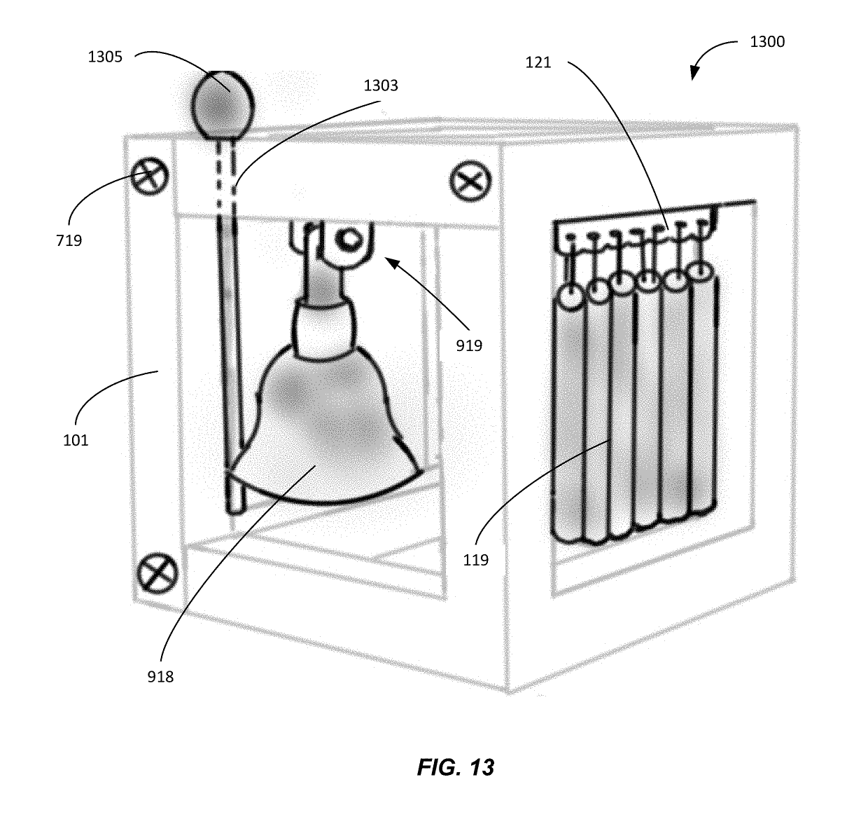

Referring to the multi-connector 121 illustrated in FIGS. 9 and 13, being similar to the connector 103, the multi-connector 121 may be used to connect music devices to connect one or more frame members of the music station. In a preferred implementation of the invention, the multi-connector 121 connects multiple music devices, such music devices having multiple music device notes or keys, such as chimes (119) or other like musical instruments known in the art. The multi-connecter 121 may also have more than one opening along the multi-connecter 121 for threading multiple wires 909 for connecting music device notes or keys as discussed above. The length of the multi-connector 121 is not limited, and can be as long or as short as necessary for the type of music device to be connected.

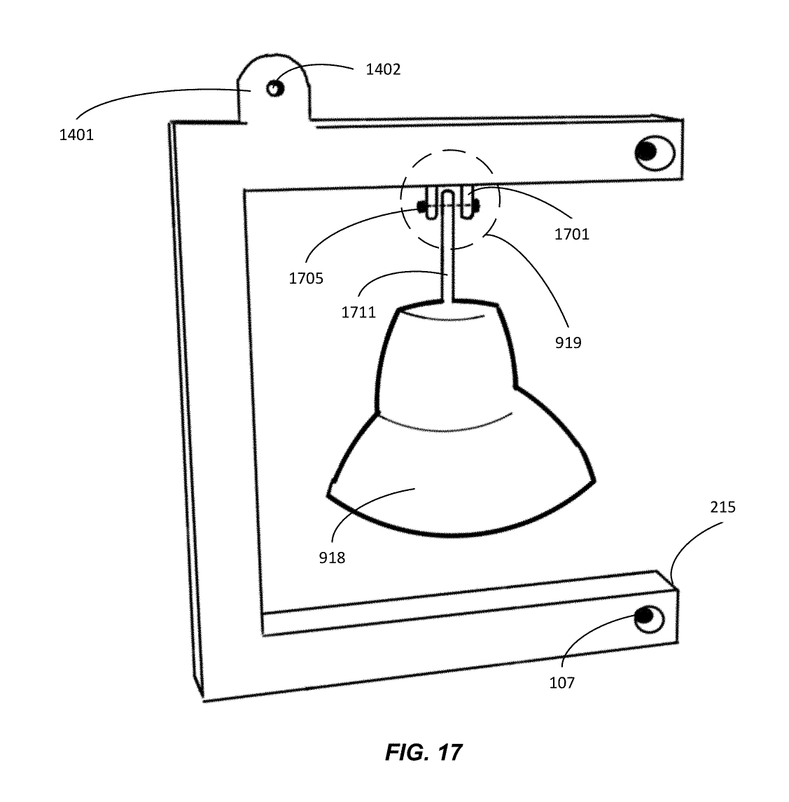

The parallel connector 919 as shown in FIG. 9 may also be used to connect one or more music devices to music station frame members. As shown in FIG. 9, in one implementation, the parallel connector 919 can be used to connect music devices such as a Bell 918 to the cube upper connect 200. In another embodiment, the parallel connector can be used to connect music devices having a weight or size that would not be suitable for using wires 909 to connect the music devices to frame members of the music station. Example illustrations of the parallel connector 919 are shown in FIG. 13 and FIG. 17.

As shown in the example illustration of FIG. 17, in one example the parallel connector 919 includes two tabs 1701 having openings extending throughout each, similar to the opening in connector 103. The openings within the tabs 1701 in a preferred implementation however, are not used to thread wire 909 within, but instead a music device bolt 1705 may be inserted through the openings (not shown) of each of the parallel connector tabs 1701. In an embodiment, the bolt adds stability to the parallel connector 919. The music device bolt 1705 may be a bolt or other like fastening device known in the art.

Now that the music station cube configuration 100 has been described using three music station frame members i.e., a cube stabilizer 300, an upper connect 200, and a cube panel 500, the description will now focus on additional implementations of the cube configuration of the music station. Referring now to FIGS. 12A-12B, example illustrations of the cube configuration 100 using different frame members are shown.

As shown in FIGS. 12A and 12B, although the preferred embodiment of the invention includes connecting three frame members, other implementations may be used to configure the cube configuration 100. In one embodiment, referring to FIG. 12A, the cube configuration 100 may include one or more cube mirror connects 1203. As shown, the cube configuration 100 has been implemented by using two cube mirror connects 1203, which connect to each other at each end.

In an embodiment, each cube mirror connect 1203 may have one side which contains a top and a bottom frame insert 201. Moreover, as shown, each cube mirror connect 1203 has an opposite side which contains upper and lower insert sockets 215 (not shown). Although the insert socket 215 for each cube mirror connect 1203 are not illustrated, in order to connect the two frame members, the frame inserts 201 of each cube mirror connect 1203 are inserted into the other cube mirror connect's 1203, insert sockets 215 as illustrated and described above. Once the frame inserts 201 of each mirror connect 1203 has been inserted into the other cube mirror connect's 1203 insert sockets 215, frame bolts 719 may be used to connect the two frame members.

Referring now to the example illustration in FIG. 12B, additional frame members may be used to implement the cube configuration 100 of the music station. As shown, in an implementation, a table connect 1209 is illustrated as being connected to a cube panel 500 frame member. In one embodiment, the table connect 1209 has four frame inserts 201 extending from each arm of the table connect 1209 as shown, which frame inserts 201 have been inserted into the four insert sockets 215 of the cube panel 500 of FIG. 5A. As described above, frame bolts 719 may be inserted into each of the cube panel 500 outer openings 107, through each of the frame insert openings 211 of the frame inserts 201 to connect the two frame members i.e., the table connect 1209 and the cube panel 500, in order to form the music station cube configuration 100.

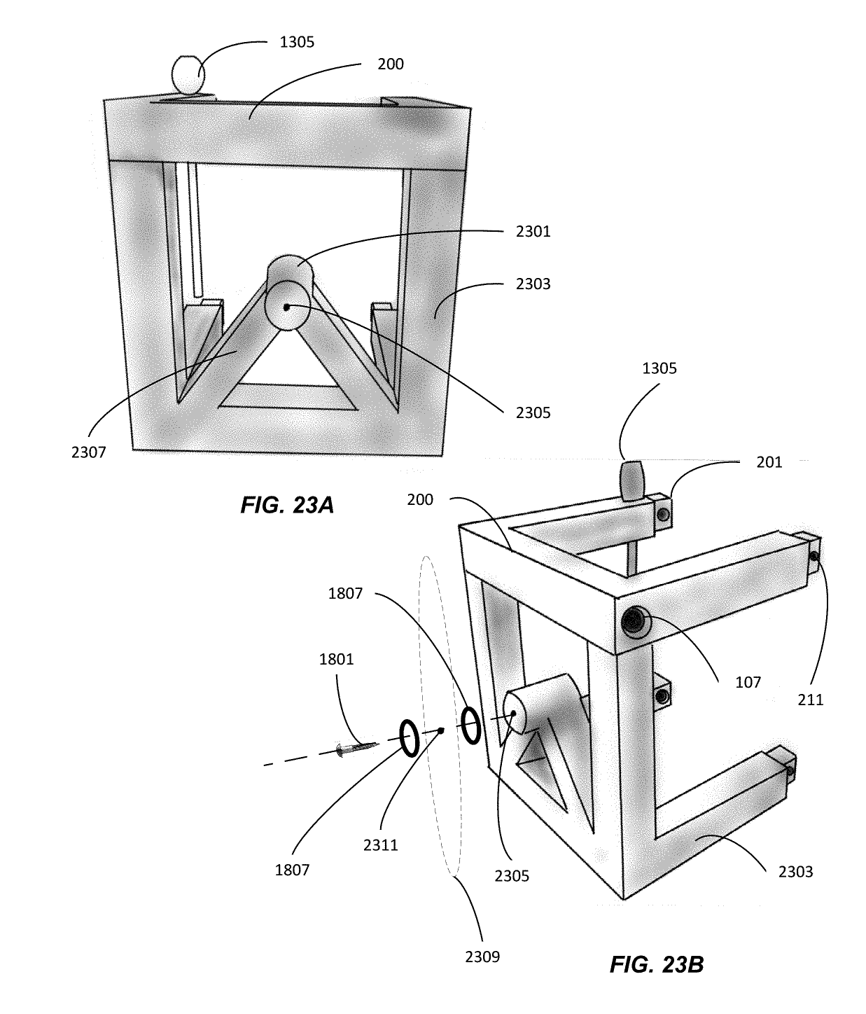

As illustrated in FIGS. 23A and 23B, other frame members can be used to implement the cube configuration 100. As shown, another example cube configuration 100 having a modified cube stabilizer 2303 is shown according to the present disclosure. The modified cube stabilizer 2303 is similar to cube stabilizer 300 discussed above, except that the modified cube stabilizer 2303 also includes a stabilizer mount 2301 and mount frame 2307, wherein the stabilizer mount 2301 is disposed on the mount frame 2307. In a preferred embodiment, the stabilizer mount 2301 and mount frame 2307 are part of the modified cube stabilizer 2303; however, in other embodiments, either or both may be attached or disposed on the modified cube stabilizer 2303 using screws, bolts, nails, adhesive or the like. In one embodiment, the stabilizer mount 2301 of the modified cube stabilizer 2303 may protrude outward relative to the spatial plane of the face of the mount frame 2307, wherein additional music devices may be connected.

In one embodiment, the modified cube stabilizer 2303 as shown in FIGS. 23A and 23B, may be connected with other frame members of the cube configuration 100 in a similar fashion as the cube stabilizer 300. For example, the modified cube stabilizer 2300 may be connected to both the cube upper connect 200 and the cube panel 500 similarly to the cube stabilizer 300. However, as shown in FIG. 23B, in another embodiment additional music devices depicted by 2309, such as a cymbal or other device may be connected to the stabilizer mount 2301 using an opening 2305 within the modified cube stabilizer 2303.

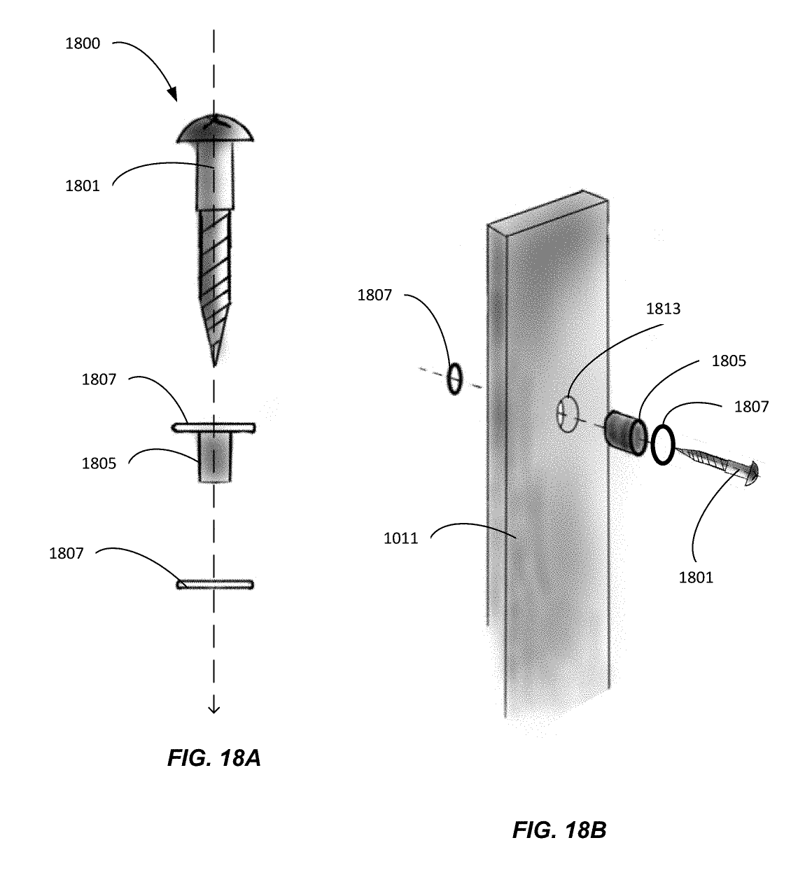

Although only some music devices have been described, the invention is not limited and any music devices that can be connected using the connectors and mounts herein may be used. As illustrated in FIG. 23B, in one embodiment, and as discussed below, the music devices mentioned above may be connected to the modified stabilizer 2303 using screws 1801 and washers 1807, or using a mounting screw assembly 1800 as discussed further below in reference to FIGS. 18A and 18B. Using the example above however, screws may be bolts, nails, or other like connection devices. The modified cube stabilizer 2303, the cube mirror connect 1203, and the cube table connect 1209 are music station frame members and may be used to form the cube configuration 100 of the music station.

FIG. 13 illustrates another example of the cube configuration 100 having connectors (103, 121, and 919) and music devices disposed, according to the present disclosure. As illustrated, music devices such as a bell 918 and chimes 119 are shown connected to the music station using the connectors (103, 121, and 919) discussed above with reference to FIG. 9. In one implementation, referring to FIG. 13, one or more accessory devices 1305 may also be disposed on the frame members of the music station. In one example, an accessory device 1305 may be one or more of a drumstick, a mallet, a hammer, or other like music device accessories 1305.

An accessory holder 1303 in one embodiment of the invention can either be an opening within a frame member of the music station where and an accessory device 1305 may be disposed, as illustrated in FIG. 13. In another embodiment however, an accessory holder 1303 may be a device made of plastic, leather, or other like material that can be attached to the music station using screws bolts nails or the like, and used for holding or housing one or more accessory devices 1305. Also shown in FIG. 13, frame bolts 719 are installed within the outer openings 107 (not shown) of the frame members in order to connect the frame members of the cube configuration 100. As described above, in an embodiment of the invention, the outer openings 107 have an outer opening offset 511 which allows each of the frame bolts to fit completely within the frame members. This is so that no part of the frame bolt 719 protrudes from the frame members, but instead fit completely within the frame openings 107.

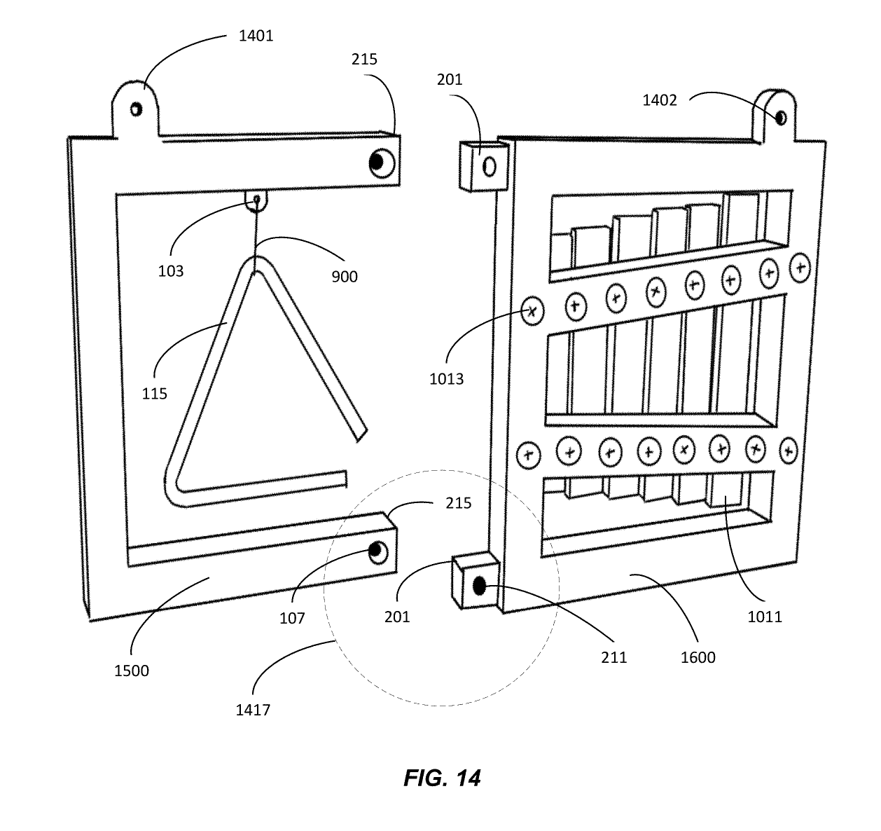

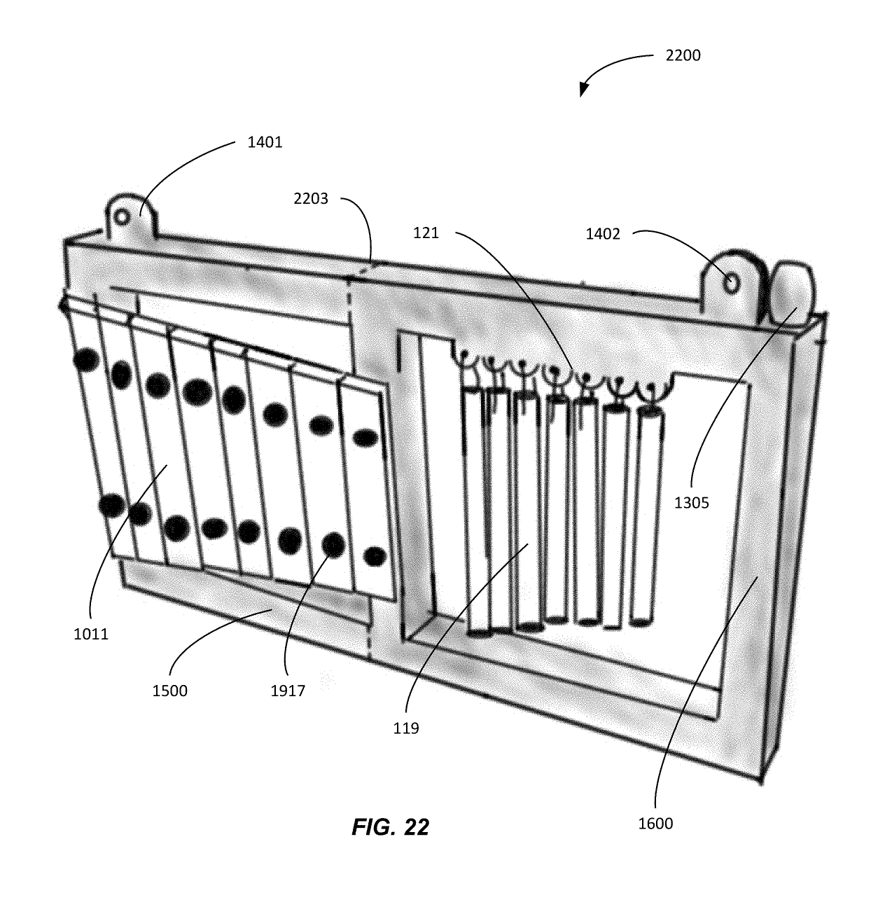

FIG. 14 illustrates example frame members of a rectangle configuration 2200 of the music station, according to the present disclosure. The connected rectangle configuration 2200 as illustrated in FIG. 22, is similar to the other configurations of the music station at least in that the frame inserts 201, insert sockets 215, and frame bolts 719 are used to connect the frame members. As shown in FIG. 14, and although not limited to, the preferred embodiment of the rectangle configuration 2200 has two frame members, a rectangle connector 1500 and a rectangle panel 1600.

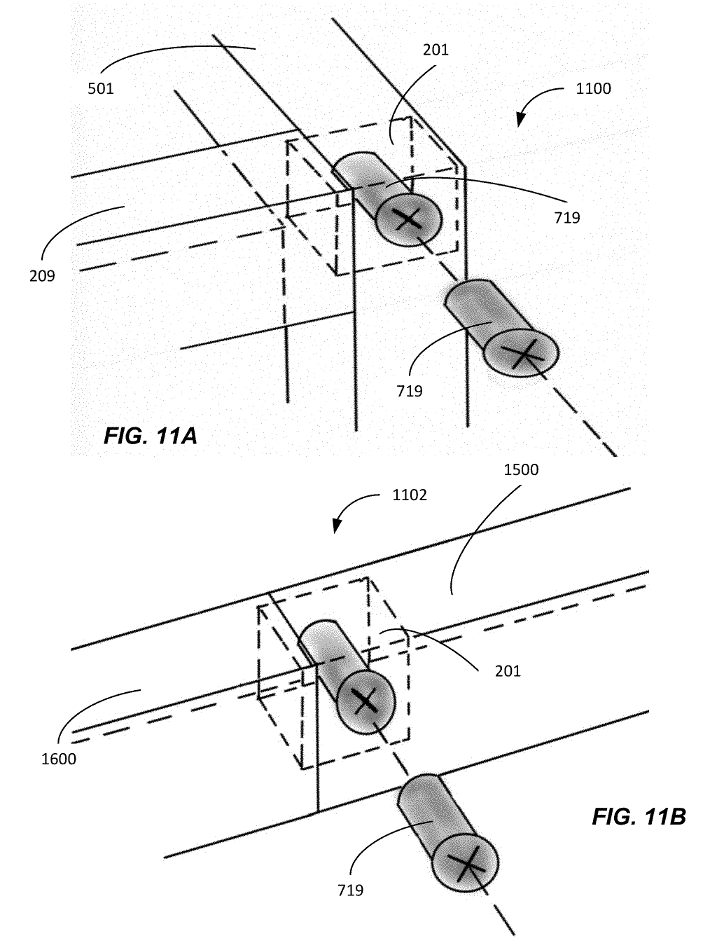

In another embodiment, the rectangle configuration 2200 is configured in the form of a rectangle and includes two or more rectangle frame members as discussed above. In yet another embodiment, the outer openings 107 extend into the rectangle frame members similar to other configurations of the music station e.g., the cube configuration 100, wherein the outer openings 107 and insert sockets 215 traverse each other perpendicularly, and the frame members are connected using frame bolts 719 as illustrated in FIGS. 6, 7, and FIG. 11B. Referring back to FIG. 14, frame bolts 719 are inserted into the outer openings 107, which are indicated by the black dots on the exterior of the rectangle connector 1500. Moreover, in an embodiment of the invention the diameter of the outer openings 107 of the rectangle configuration 2200, and other configurations of the music station, may be similar to the diameter of the outer openings 107 within the cube configuration 100.

In another embodiment however, the rectangle configuration 2200 may also include interactive frame members 111 on one or more rectangle frame members. Further, as illustrated in FIG. 14, the rectangle configuration 2200 may have one or more connectors 103, multi-connectors 121, as well as other connectors such as parallel connectors 919 in order to connect music devices to the music station. The connectors discussed above may be used to connect music devices such one or more a triangle 115, chimes 119, a bell 918, xylophone keys 1011, and or other music devices; however other music devices may also be used and or connected to the configurable music station such as cymbals or other devices.

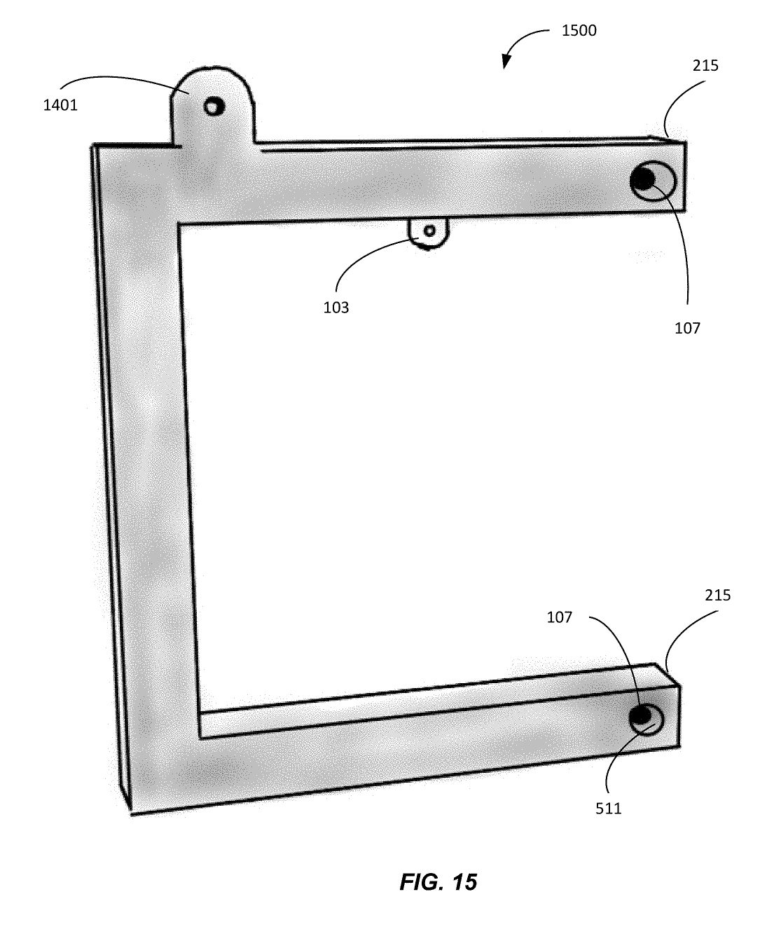

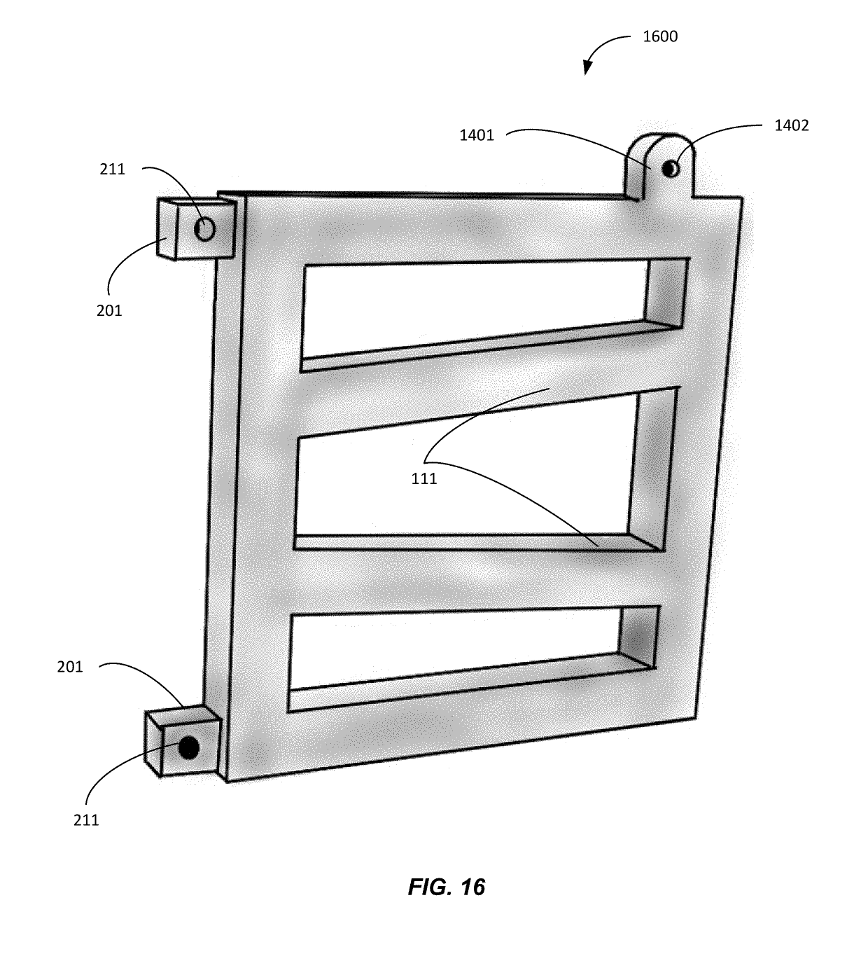

Referring now to the rectangle configuration's 2200 frame members. As shown in FIG. 15, in a preferred embodiment of the invention, the rectangle connect 1500 has the shape of a horseshoe. Also, although not limited, the rectangle connect 1500 can be a single frame member which includes upper and lower insert sockets 215. In a preferred embodiment, the rectangle connect 1500 and or the rectangle panel 1600 may have one or more insert sockets 215 and or frame inserts 201. Also, in a preferred implementation, the vertical height of the rectangle connect 1500 of FIG. 15 and the rectangle panel 1600 of FIG. 16 is nine inches, while the horizontal length of the rectangle connect 1500 and the rectangle panel 1600 is 8 inches, wherein the height and length of the rectangle configuration 2200 is nine inches high by 16 inches long. However, in other embodiments, the dimensions of the rectangle configuration 2200 may vary.

Referring again to FIG. 14, in a preferred embodiment, each of the upper and lower frame inserts 201 of rectangle panel 1600, are inserted within the upper and lower insert sockets 215 of rectangle connect 1500. Once the frame inserts 201 are inserted into the insert sockets 215, frame bolts 719 may be inserted into the outer openings 107 of the upper and lower insert sockets 215 of the rectangle connect 1500, as shown to connect the two frame members.

Referring now to the example illustration of FIGS. 18A and 18B. As shown, an example of a mounting screw assembly 1800 that may be used to secure musical device keys 1011 to interactive frame members 111 is shown. Further, as shown in FIG. 14 referring to the rectangle panel 1600, music keys 1011 (such as the keys of a xylophone) in a preferred embodiment of the invention are connected to the interactive frame members 111 using a locking pin assembly 1900, as discussed in detail below.

In other embodiments however, music keys 1011 can be disposed on the interactive frame members 111 using a mounting screw assembly 1800 as illustrated in FIGS. 18A-18B. In one implementation, the music keys 1011 comprise aluminum hand polished keys 1011 and have a thickness of ¼″. In other implementations, the above dimensions may differ. The mounting screw assembly 1800 as shown in FIGS. 18A-18B may include mounting screws 1801 that may be disposed within washers 1807 and an insulator 1805 as shown.

In another embodiment however, other screws, bolts, or like devices for securing music keys 1011, or other music devices to interactive panels 111 may be used as mounting screws 1801. Referring back to the illustration in FIGS. 18A-18B, in one embodiment of the invention the insulator 1805 and washers 1807 comprises plastic, and each washer 1807 comprise “O” rings on either side of the music keys 1011. At least one purpose for this is so to reduce or prevent metal on metal contact, and unwanted noise during music device interaction.

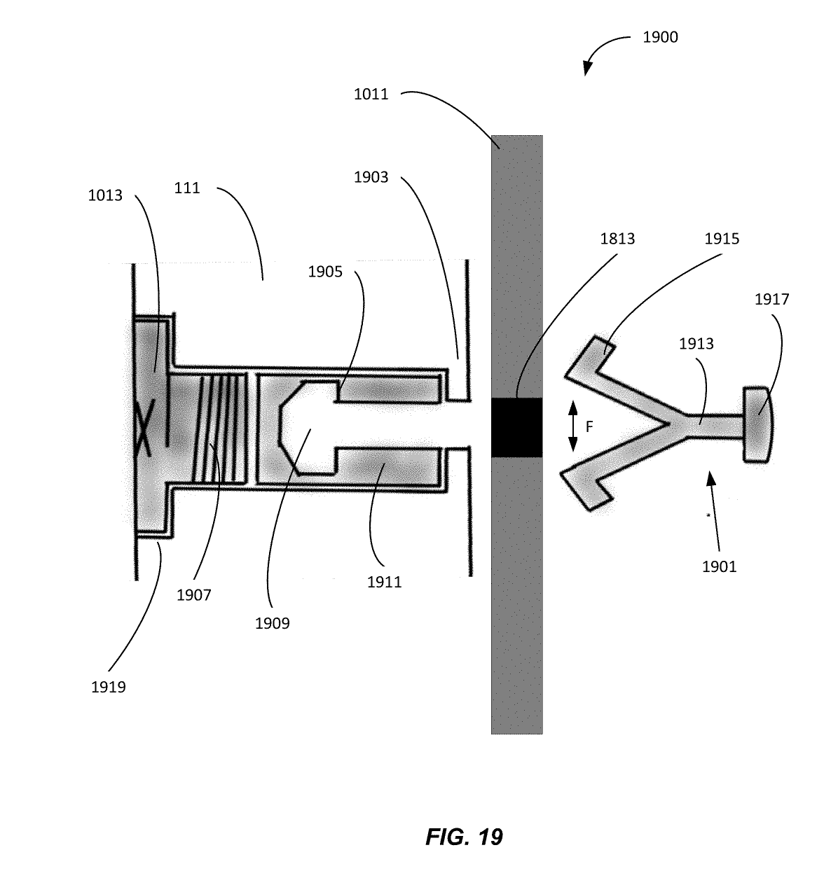

Referring now to the example illustrated in FIG. 18B, a mounting screw is shown being disposed into a key opening 1813. As illustrated, the mounting screw assembly 1800 includes an insulator 1805, and one or more washers 1807. As shown, the insulator 1805 is disposed in the key opening 1813, where the insulator 1805 also has a hole through it to allow the screw 1801 to be inserted through the music key 1011 and disposed within the interactive frame members 111 (as shown in FIG. 16). Again, although using a mounting screw assembly 1800 to connect music devices to the interactive panels 111 as described above may be used in some embodiments, the preferred embodiment of the invention uses a locking pin assembly 1900 as shown in FIG. 19.

FIG. 19 illustrates an example locking pin assembly being used to lock a musical device key 1011 to an interactive frame member, according to the present disclosure. In one embodiment, the locking pin assembly of FIG. 19 includes a locking pin 1901, which has a pin top 1917, a pin neck 1913, and two or more pin feet 1915. Also, in another example implementation, the locking pin assembly 1900 may include either a threaded or an unthreaded insert (2011, 1911), respectively, which is completely disposed within a locking pin opening 109 of an interactive frame member 111, and a pin plug 1013.

In a preferred embodiment, the locking pin 1901 and the insert (2011, 1911) is comprised of a hard-plastic material; however, in other implementations the locking pin 1901 and the insert (2011, 1911) may be comprised of other material such as wood, metal, or the like. Further, as shown, and as labeled “F” in the illustration of FIG. 19, a force “F” between the locking pin feet 1915 pushes the pin feet 1915 outward. In a preferred embodiment, the hard-plastic material of the locking pin 1901 is designed to create the force “F” between the pin feet 1915.

As discussed below however, in one embodiment this outward force “F” forces each pin foot 1915 to lock within the insert (2011, 1911), in turn locking the insert (2011, 1911) within the interactive frame member 111. Using this example, the locking pin 1901 is first inserted through the music key opening 1813 and into the threaded or unthreaded insert (2011, 1911), respectively, depending upon the desired configuration. As shown in FIG. 19, the unthreaded insert 1911 may be cylindrical in shape and sized to fit within the locking pin opening 109.

In one embodiment, using the unthreaded insert 1911, the interactive frame member opening, facing the music device key 1011 being mounted, as shown in FIG. 19 has a smaller diameter, than the diameter of the locking pin opening 109 where the locking pin plug 1013 is inserted and secured. In one embodiment of the invention, once the locking pin 1901 is inserted through the music key opening 1813 and into the locking chamber 1909 of the unthreaded insert 1911, the locking pin will be locked in place due to the outward force of the locking pin feet being forced outward and engaging with the locking edge 1905 of the unthreaded insert 1911 or the threaded insert 2011 discussed below.

In the above example, once the locking pin 1901 is inserted into an insert (2011, 1911) disposed within the locking pin opening 109, and a locking pin plug 1013 is inserted and secured within the locking pin opening 109, the locking pin will be locked, and the insert 1911 will not be able to be removed from within the locking pin opening 109 due to the locking pin plug 1013. In either implementation using a threaded or unthreaded insert (2011, 1911) however, if someone attempts to unscrew the locking pin 1901 by turning it from above once it has locked, it will simply spin freely. However, if the locking pin 1901 is sheared or broken, the locking pin plug 1013 can be taken out, and the insert (2011, 1911) removed and replaced with a new insert (2011, 1911) or locking pin assembly 1900. The locking mechanism of the locking pin assembly 1900 helps to prevent choking or other hazards of other devices, due to other devices having loose parts, and also makes the music station more easily repairable.

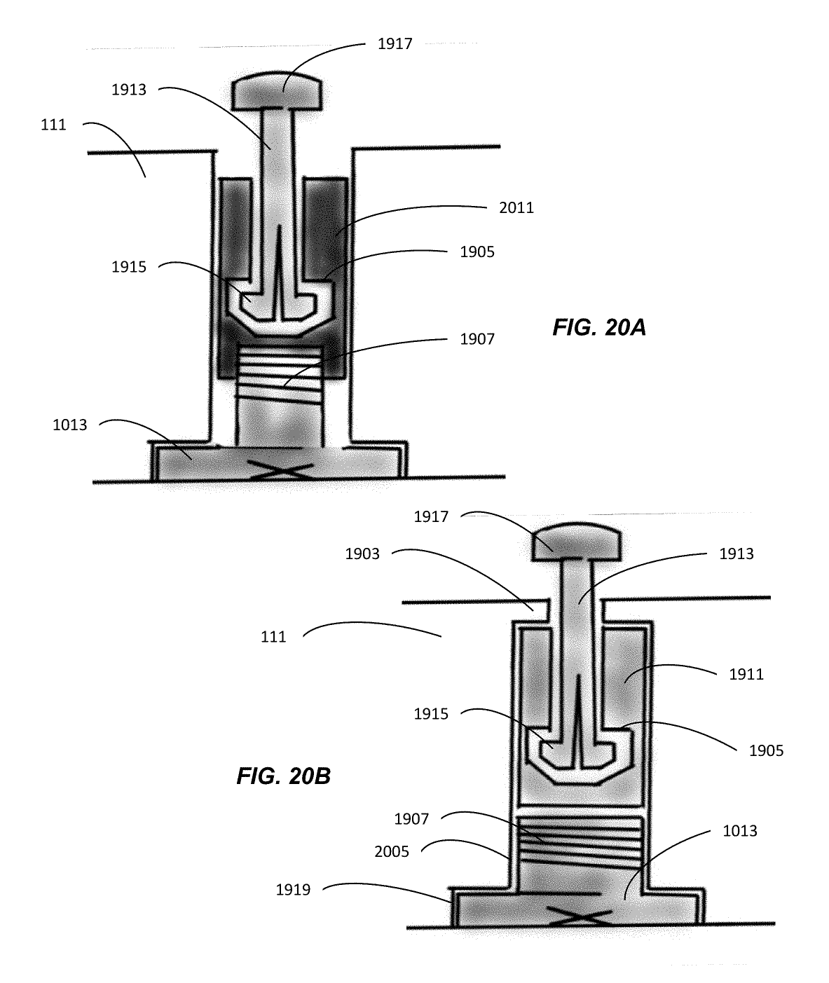

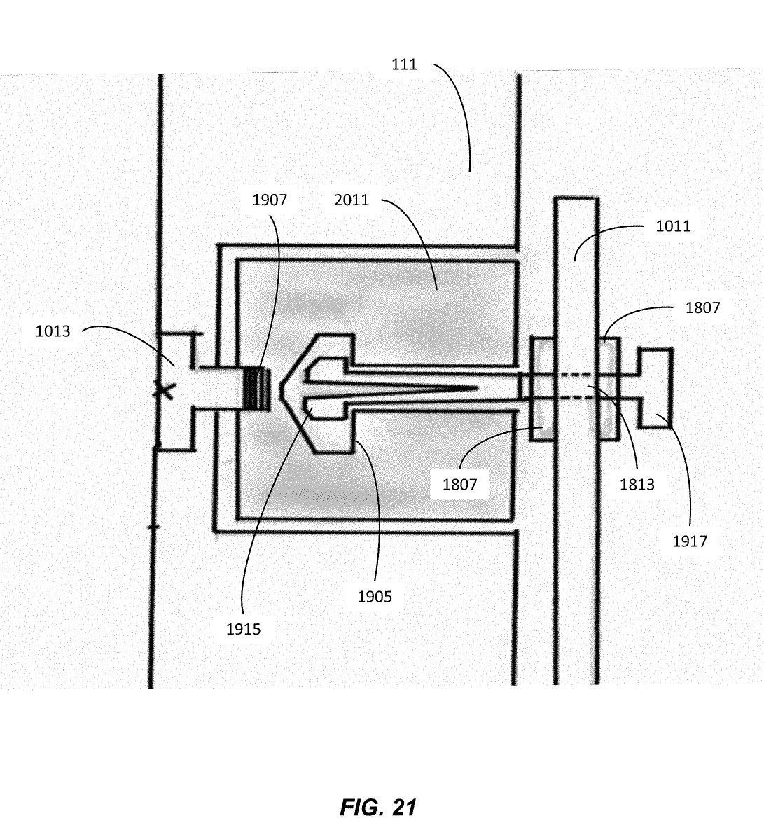

In yet another embodiment however, referencing FIG. 20A and FIG. 21, a locking pin assembly 1900 is illustrated including a threaded insert 2011, and a locking pin plug 1013 which can be inserted and locked within the threaded insert 2011. In this embodiment, the diameter of the locking pin opening facing the music device does not have to be smaller than the diameter of the insert 2011, because in this implementation the locking pin plug 1013 establishes the lock by being secured within the threaded insert 2011, not by using the frame member stop 1903 as shown in FIG. 19 due to the opening having a smaller diameter as discussed above.

Using the examples illustrated in FIG. 20A and FIG. 21, in a preferred embodiment, to keep the threaded insert 2011 and locking pin 1901 locked in place, thereby connecting the music key 1011 to the interactive panel 111, the locking pin plug 1013 has a diameter smaller than the threaded insert 2011, and is screwed into and locked within the threaded insert 2011 at the locking pin opening 109. Also, referring again to FIGS. 20A and 20B, as shown the locking pin plug 1013 can fit completely against the interactive frame member 111 at the locking pin opening 109, as the locking pin opening 109 has a plug offset 1919 which allows the entire plug 1013 to be disposed within the locking pin opening 109.

Referring again to the illustration of FIG. 22, the rectangle configuration 2200 of the music station is shown connected. In a preferred embodiment, each rectangle configuration 2200 frame member, e.g., the rectangle connect 1500 and the rectangle panel 1600 is connected to each other at connection point 2203. The connection point is the point where each frame insert 201 (not shown) is inserted into each insert socket 215 of the other rectangle frame member. As shown in FIG. 22 there is an upper and a lower connection point (which are indicated by the dotted lines), and the rectangle configuration 2200 is connected once frame bolts 719 are inserted into the outer openings 107, through the insert sockets 215 of the opposite rectangle frame member, and secured.

Illustrated in FIG. 22 is also a plurality of music keys 1011 that have been disposed on interactive frame members (not shown) of the rectangle connect 1500 frame member. In a preferred embodiment, each of the music keys 1011 illustrated have a locking pin 1901 disposed within the music key openings 1813, locking the music keys to the interactive frame members. As discussed, because of the locking mechanism of the locking pin assembly 1900, none of the locking pins 1901 or music keys 1011 can be removed or detached.

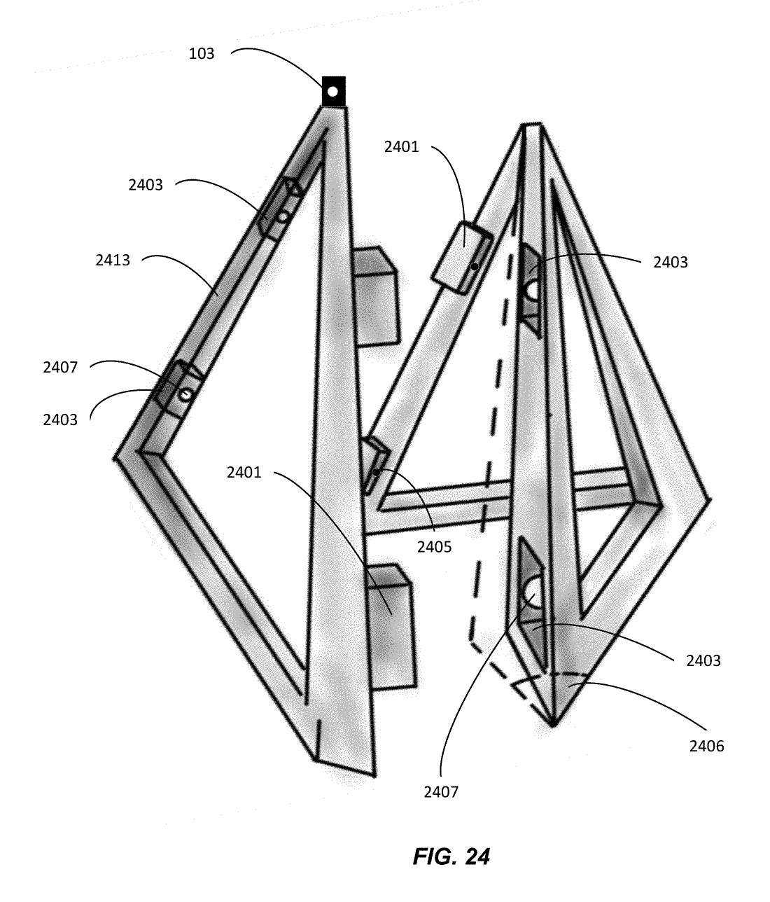

FIG. 24 illustrates example frame members of a pyramid configuration 2600 of the music station, according to the present disclosure. As illustrated, in a preferred embodiment of the invention the pyramid configuration 2600 includes three pyramid connect 2413 frame members. As shown, each pyramid connect 2413 has the shape of a triangle, and in a preferred embodiment each has at least two pyramid inserts 2401 on one side, and at least two pyramid insert sockets 2403 on the other side.

In one embodiment, the number of pyramid inserts 2401 and pyramid insert sockets 2403 may differ, and the sides of each pyramid connect 2413 may have one or more pyramid inserts 2401 and pyramid insert sockets 2403. In a preferred embodiment however, the length of each side of the pyramid connect 2413 is 6.5 inches; however, in other embodiments the length of each side may be more or less, in some implementations between 6 and 9 inches and forms the shape of an acute triangle.

As shown in FIG. 24, in a preferred implementation the pyramid inserts 2401 are cubical in shape, and extend from the sides of the pyramid connect 2413 about an inch, wherein pyramid insert sockets 2403 on other pyramid connects 2413 are similarly sized to allow the pyramid inserts 2401 to be inserted within. The size and shape of the pyramid inserts 2401 and the pyramid insert sockets 2403 may differ in some embodiments. However, in a preferred embodiment the pyramid inserts 2401 each have a pyramid insert opening 2405 which aligns with pyramid frame openings 2407 within the pyramid insert sockets 2403, as shown.

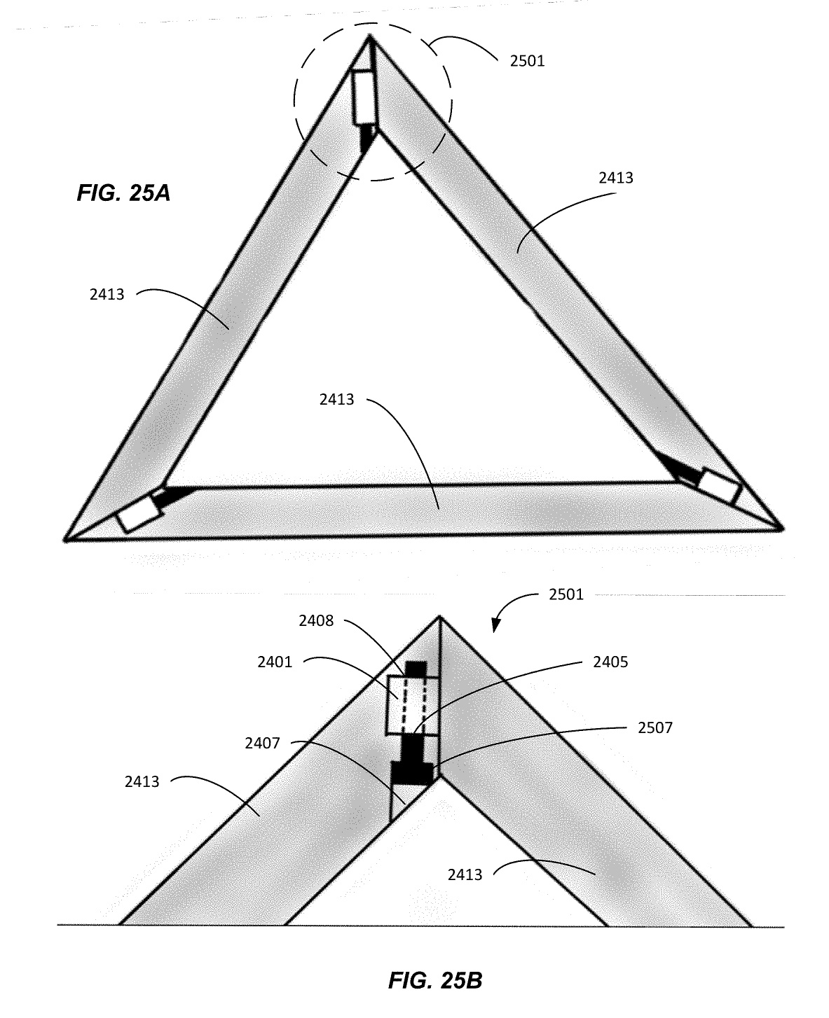

The connections for the pyramid configuration 2600 are similar to the connections discussed above related to the cube and rectangle configuration connections, but that the pyramid configuration 2600 has no outer openings 107. Instead, as illustrated, the outer opening 107 (not shown) is replaced with pyramid frame openings 2407 which are on the inside of each pyramid connect 2413 frame member. Also, as illustrated in FIG. 24, the outer edges of each pyramid connect 2413 frame member is angled to create an acute triangle at the base of the pyramid configuration 2600, wherein the angle formed at the junction of each frame member is 60 degrees. This is illustrated further in FIGS. 25A and 25B.

FIGS. 25A-25B illustrate a top down cross-sectional view of the pyramid configuration 2600 showing example connections according to the present disclosure. As illustrated in FIG. 25A, in the preferred embodiment each pyramid connect 2413 is connected to the other pyramid connect 2413 frame members, wherein at the base of the pyramid configuration 2600 an acute triangle is formed wherein each angle is 60 degrees. Referring to the connection indicated at 2501 and FIG. 25B, as illustrated a pyramid insert 2401 is inserted into a pyramid insert socket 2403 (not shown), and the connection is made once a frame bolt 719 is inserted into the pyramid frame openings 2407, through the pyramid insert opening 2405 and is secured by threading the bolt within the pyramid connect 2413.

In a preferred embodiment, the pyramid frame openings 2407 have a pyramid frame offset as shown in FIG. 25B, wherein once the frame bolt is inserted in the pyramid frame opening 2407 no part of the frame bolt protrudes from the frame member; however, in other embodiments no offset may be used. In another embodiment, once the frame bolts 719 have been inserted and secured into pyramid frame openings 2407, and the pyramid connect 2413 frame members are connected to form the pyramid configuration 2600 of the music station, the frame offset within the pyramid frame openings 2407 may be filled with a filler such as an epoxy, or other hardening material used in the art, to fill the pyramid frame openings 2407.

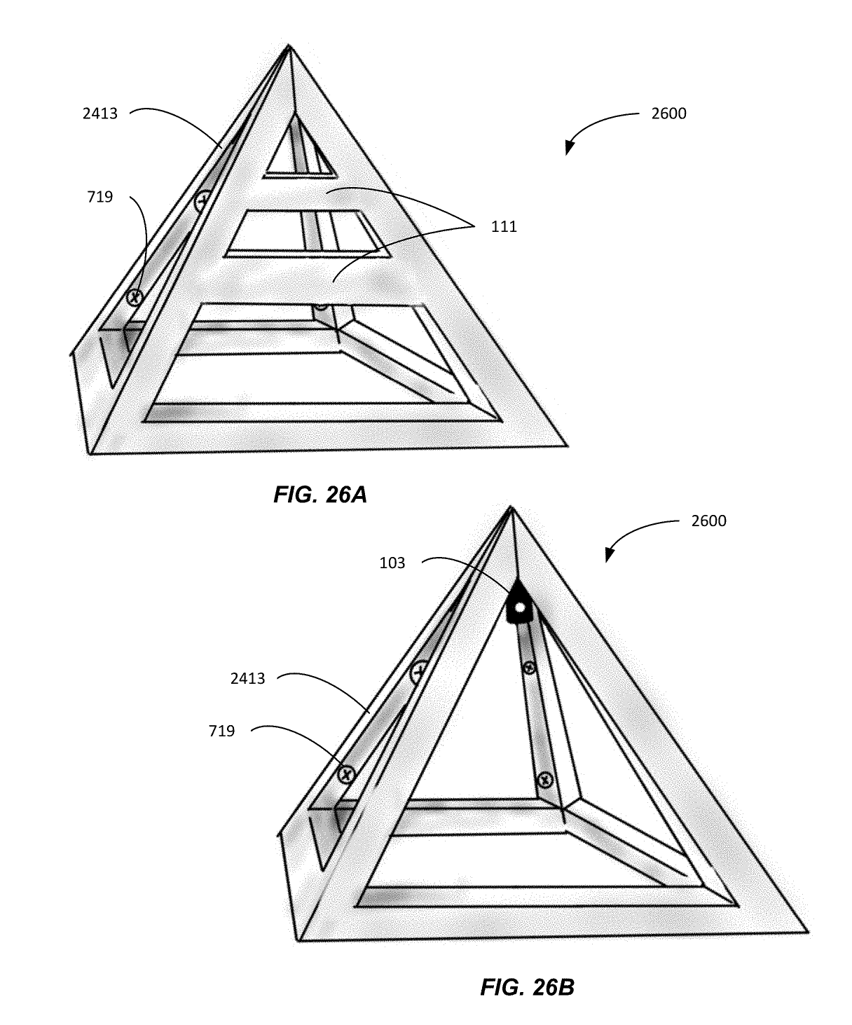

FIGS. 26A-26B illustrate example pyramid configurations 2600 of the music station, according to the present disclosure. As shown in FIG. 26A, a pyramid configuration 2600 has been implemented using three pyramid connect 2413 frame members 2413. As shown, in one implementation the pyramid connect 2413 frame members may have one or more interactive frame members 111 for connecting music devices as described above. Moreover, as shown FIG. 26A and FIG. 26B, in an implementation of the invention an epoxy or other material may not be used and the secured frame bolts 719 may be visible. Also, as illustrated in FIG. 26B and as explained above, in another implementation music devices may be connected to one or more of the pyramid connect 2413 frame members using connectors (103, 121, and 919) as described above.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, Applicants desire all patent rights afforded by the appended claims. Therefore, it is intended that the appended claims include all modifications and alterations to the full extent that they come within the scope of the appended claims or equivalents thereof.

1. A musical learning apparatus comprising:
at least two frame members;
one or more connectors disposed on at least one of the frame members;
wherein one or more music devices are connected to the frame members using the connectors;
wherein the frame members are connected using frame bolts; and
wherein when the frame members are connected they form a geometric shape.

2. The musical learning apparatus of claim 1, wherein at least one of the frame members include one or more interactive frame members.

3. The musical learning apparatus of claim 2, wherein the one or more interactive frame members include locking pin openings.

4. The musical learning apparatus of claim 2, wherein music devices are connected to the interactive frame members using a locking pin assembly.

5. The musical learning apparatus of claim 2, wherein music devices are connected to the interactive frame members using a mounting screw assembly.

6. (canceled)

7. The musical learning apparatus of claim 1, wherein geometric shapes include a cube, a rectangle, and a pyramid.

8. A musical learning apparatus comprising:
at least two frame members;
one or more connectors disposed on at least one the frame members;
wherein one or more music devices are connected to the frame members using the connectors;
wherein frame members are connected when frame bolts are secured within separate frame members; and
wherein when the frame members are connected they form a geometric shape.

9. The musical learning apparatus of claim 8, wherein at least one of the frame members include one or more interactive frame members.

10. The musical learning apparatus of claim 9, wherein the one or more interactive frame members include locking pin openings.

11. The musical learning apparatus of claim 9, wherein music devices are connected to the interactive frame members using a locking pin assembly.

12. The musical learning apparatus of claim 11, wherein the locking pin assembly includes a locking pin, an insert, and a pin plug.

13. The musical learning apparatus of claim 8, wherein music devices are connected to the interactive frame members using a mounting screw assembly.

14. The musical learning apparatus of claim 8, wherein geometric shapes include a cube, a rectangle, and a pyramid.

15. A musical learning apparatus comprising:
at least two frame members;
one or more connectors disposed on at least one of the frame members;
wherein one or more music devices are connected to the frame members using the connectors;
wherein frame members have one or more frame inserts and insert sockets;
wherein frame members are connected when a frame bolt is secured within the outer opening of a frame member and the frame insert of a separate frame member; and
wherein when the frame members are connected they form a geometric shape.

16. The musical learning apparatus of claim 15, wherein at least one of the frame members include one or more interactive frame members.

17. The musical learning apparatus of claim 16, wherein the one or more interactive frame members include locking pin openings.

18. The musical learning apparatus of claim 16, wherein music devices are connected to the interactive frame members using a locking pin assembly.

19. The musical learning apparatus of claim 16, wherein music devices are connected to the interactive frame members using a mounting screw assembly.

20. The musical learning apparatus of claim 15, wherein geometric shapes include a cube, a rectangle, and a pyramid.
